(19) United States
(12) Patent Application Publication
(10) Pub. No.: US 2007/0106735 A1
(43) Pub. Date: May 10, 2007

(54) Message and system for maintaining the security of transmitted personalized messages

(75) Inventor: William C. Hardy JR., Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/272,322

(22) Filed: Nov. 10, 2005

(51) Int. Cl. G06F 15/16

(52) U.S. Cl. 709/206

(57) ABSTRACT

A method for maintaining the security of transmitted embedded personalized messages sent over a communication network includes receiving messages directed to recipients having recipient destination descriptors and determining whether a message includes a personalized portion, with the personalized portion directed to one or more of the original recipients of the message. The personalized portion includes identifying designators, which are associated with one or more recipient destination descriptors. Prior to performing an operation on the message, such as forwarding the message, replying to the message, copying the message to a destination location, or deleting the message, a determination is made whether to retain the personalized portion of the message. If the recipient of the personalized portion of the message does not want the personalized portion included in any operation performed on the message, it is deleted prior to performance of the operation.

### CROSS-REFERENCE TO RELATED APPLICATIONS

The following co-pending application, U.S. application Ser. No. 11/146,641, filed Jun. 7, 2005, titled “Email System and Method for Selective Transmission of a Portion of an Email Message”, is assigned to the same assignee of the present application. The entire disclosure of this co-pending application is totally incorporated herein by reference in its entirety.

### BACKGROUND AND SUMMARY

This disclosure relates generally to message communication systems and more particularly to systems and methods for retaining the security of transmitted embedded personalized messages.

The use of word processing programs and electronic mail systems provides a quick, convenient way for computer users to communicate. Email messages are initiated by a sender, who composes the message using a text editing program and provides a list of recipients, identified in an address line. This message may then be sent to the recipients' computer addresses. However, a case frequently arises in which the sender wishes to send portions of a message to a first set of recipients and to send the message in its entirety to a second set of recipients.

This is illustrated in FIG. 1, in which the sender 110 desires to send a message to the recipients 120 (Tom, Dick, and Harry) specified in the email address line. However, sender 110 wants only a particular recipient, Harry, to receive the entire message. The other recipients, Tom and Dick are to receive only the non-personalized portion of the message. In this example portion 130 is the personalized portion of the message and is identified in brackets. As is known in the art, various approaches are known for identifying segments of messages for personalization and transmission. When the message is transmitted, Harry receives the entire message, in which the personalized portion is identified.

Similarly, audio communication systems provide the capability for users to include an embedded personalized message when creating a voicemail message. In this case, the personalized portion of the voicemail message may be indicated by key tones used to designate the start and end of the embedded message. The recipients of the voicemail message are entered via a keypad and the message is transmitted to the various recipients.

When a personalized message is received, it may be deleted, stored, responded to, or forwarded to additional recipients. With the exception of the deletion option, any of these actions could result in the loss of privacy of the personalized portion of the message. To protect the privacy of such messages, the recipient would need to generate a new message or messages, omitting the personalized portion of the original message, to permit responding to or forwarding a message with an embedded personalization. Therefore, what is needed is a message communication system that allows a recipient of a personalized message to reply to or forward the message without having to generate a new message for other recipients. For the reason stated above, and for other reasons stated below which will become apparent to those skilled in the art upon reading and understanding the present specification, there is a need in the art for a method of allowing a recipient of a personalized message to maintain the security of the personalized message while performing various operations on the received message.

All U.S. patents and published U.S. patent applications cited herein are fully incorporated by reference. The following patents or publications are noted:

U.S. Pat. No. 6,775,689 to Raghunandan (“System for Restructuring Selected Parts of Email Messages Prior to Transmission to Plurality of Recipients”) describes a feature in an email editor for sending selected segments of email contents to selected recipients by segmenting the email contents in the body of the email editor into a plurality of segments and identifying in the header of the email editor a recipient list for each segment. To implement this feature, a graphical user interface of a conventional email editor needs to be modified to include new fields in the header for identifying recipient lists for each segment in the body. The graphical user interface of the conventional email editor further needs to be modified to include new fields in the body to associate text/attachments with each segment.

U.S. Pat. No. 6,529,942 to Gilbert, (“System and Method for Providing Recipient Specific Formats for Electronic Mail”) teaches embedding processing codes within an email message so that selected text within the message can be changed for specific recipients based upon an identifier code corresponding to each recipient's message. An email message is then created corresponding to each specific recipient after the embedded processing codes have been correlated to each recipient.

The disclosed embodiments provide examples of improved solutions to the problems noted in the above Background discussion and the art cited therein. There is shown in these examples an improved method for maintaining the security of transmitted embedded personalized messages sent over a communication network. The method is stored and executed as an application for use by network devices. The method includes receiving messages directed to recipients having recipient destination descriptors over the communication network. The method determines whether a message includes a personalized portion, with the personalized portion directed to one or more of the original recipients of the message. The personalized portion includes identifying designators which are associated with one or more recipient destination descriptors. Prior to performing an operation on the message, such as forwarding the message, replying to the message, copying the message to a destination location, or deleting the message, a determination is made whether to retain the personalized portion of the message. If the recipient of the personalized portion of the message does not want the personalized portion included in any operation performed on the message, it is deleted prior to performance of the operation.

In another embodiment there is provided a system for maintaining the security of transmitted embedded personalized messages sent over a communication network. The system includes the capability for receiving messages directed to recipients having recipient destination descriptors. The system determines whether a message includes a personalized portion, with the personalized portion directed to one or more of the original recipients of the message. The personalized portion includes identifying designators which are associated with one or more recipient destination descriptors. Prior to performing an operation on the message, such as forwarding the message, replying to the message, copying the message to a destination location, or deleting the message, the system determines whether to retain the personalized portion of the message. If the recipient of the personalized portion of the message does not want the personalized portion included in any operation performed on the message, it is deleted prior to performance of the operation.

In yet another embodiment there is provided a computer-readable storage medium having computer readable program code embodied in the medium which causes the computer to perform method steps for maintaining the security of transmitted embedded personalized messages sent over a communication network. The method includes receiving messages directed to recipients having recipient destination descriptors over the communication network. The method determines whether a message includes a personalized portion, with the personalized portion directed to one or more of the original recipients of the message. The personalized portion includes identifying designators which are associated with one or more recipient destination descriptors. Prior to performing an operation on the message, such as forwarding the message, replying to the message, copying the message to a destination location, or deleting the message, a determination is made whether to retain the personalized portion of the message. If the recipient of the personalized portion of the message does not want the personalized portion included in any operation performed on the message, it is deleted prior to performance of the operation.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 illustrates an email message with an embedded personalized message depicted by a screen view of an email system;

FIG. 2 is a block diagram of a messagecommunication system capable of retaining the security of transmitted embedded personalized messages in electronic mail;

FIG. 3 is a flow chart illustrating a method for copying a transmitted message containing a personalized portion to an extended storage location while retaining the security of the embedded personalized message;

FIG. 4 is a flow chart illustrating a method for replying to a transmitted message containing a previously authored personalized portion while retaining the security of the embedded personalized message; and

FIG. 5 is a flow chart illustrating a method for forwarding a transmitted message with a personalized portion to an extended storage location while retaining the security of the embedded personalized message.

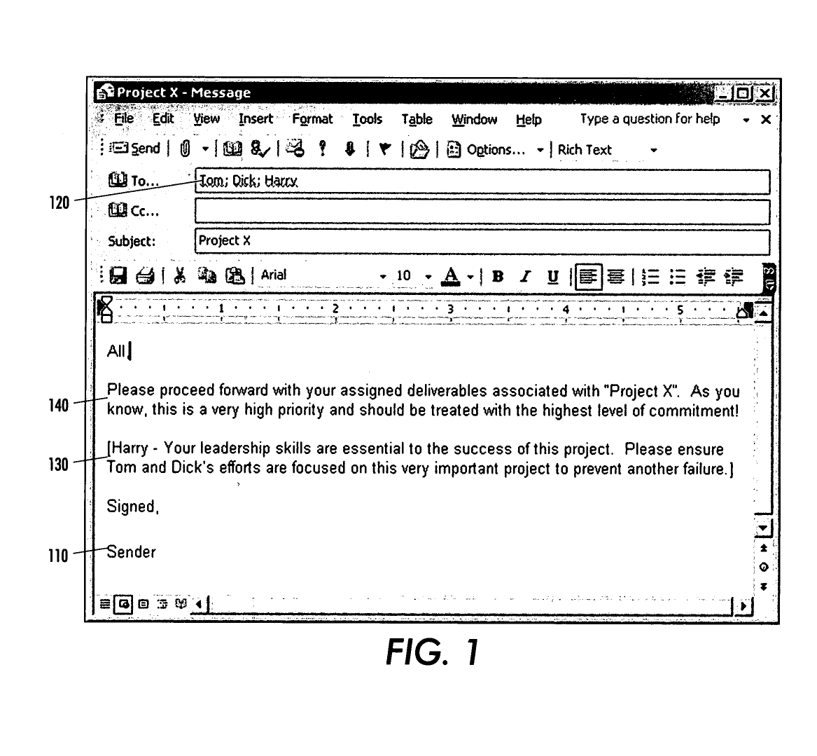

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The method and system described herein provides the capability for retaining the security of transmitted embedded personalized messages in audio or text format. While some message communication systems permit an originating user to individually customize an electronic mail message for different recipients using a single message (described more fully in U.S. application Ser. No. 11/146,641, filed Jun. 7, 2005, titled “Email System and Method for Selective Transmission of a Portion of an Email Message”), the recipient of a personalized email message remains unable to maintain the secrecy of the personalized message while performing various operations on the received message. Recipients of audio messages containing a personalized portion are confronted with the same problem if the recipient desires to save, forward, or reply to the original message. Utilizing the method and system herein, a recipient of an embedded personalized message may copy, reply to, or forward the message which retaining the secrecy of the embedded personalized portion of the message.

Various computing environments may incorporate capabilities for supporting a message creation/transmission network. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices. For the purposes of simplifying the discussion herein, example embodiments are directed to text formatted electronic mail messaging systems. However, it is noted that the method and system are not limited to such systems, but also are directed to any messaging system, including audio messaging, that present the capability of transmitting personalized messages, all of which are contemplated by the specification and scope of the claims herein.

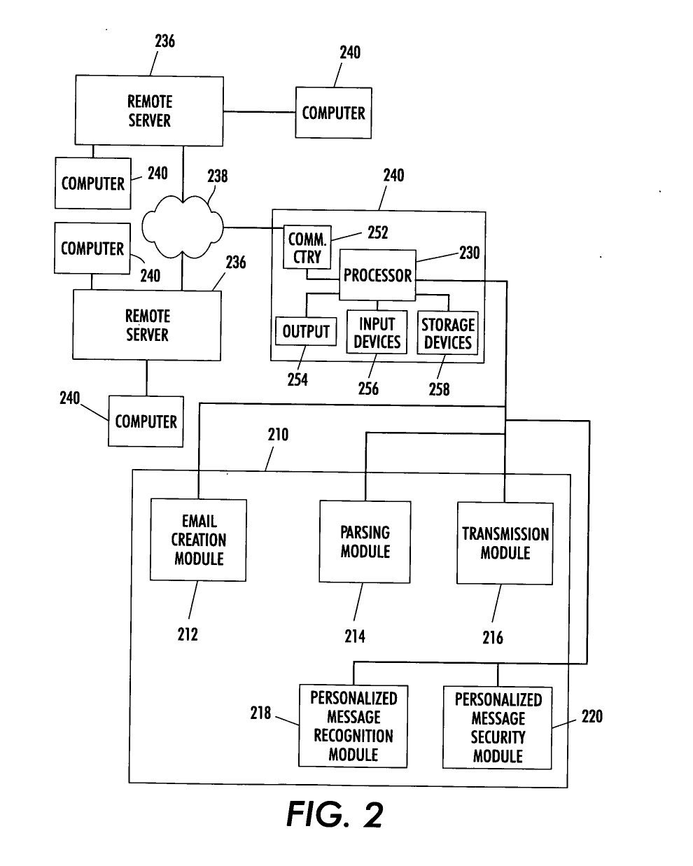

Turning to FIG. 2, the schematic diagram illustrates an example embodiment of the system for retaining the security of embedded personalized messages. The email system 210 resides on a computer network including a plurality of computers 240 having email software incorporated into each of the computers for sending and receiving email messages through communication network 238. The server 236 may also be coupled to the computers 240. Server 236 has email software stored thereon for functioning as a mail server for sending and receiving email messages through network 236.

The computers 240 typically have a processor 230, random-access memory, read-only memory, and one or more storage devices 258, such as a hard drive, CD-ROM, DVD, diskette, etc. The processor 230 is coupled to an output device 254, input devices 256, such as a keyboard, mouse, handset, or pointer, and communication circuitry 252. Handsets may be, for example, general-purpose portable computers augmented with wireless communication hardware (a “smart phone”) or mobile telephones that include an embedded processor capable of running the software described herein. Output device 254 may also include handsets or a monitor, which displays information for viewing by a user of computer 240 and input device 256 is used to control a screen pointer provided by the graphical user interface of the operating system. The system and method herein are not limited to any particular output device or input device.

As shown in FIG. 2, the computers 240 are coupled together via the network 238. In one embodiment, computer 240 includes a modem and corresponding communication drivers to connect to the Internet via what is known in the art as a “dial-up connection”. In another embodiment, the computers 240 are coupled together in only a local-area network (LAN). In yet another embodiment, the computers 240 include an Ethernet or similar hardware card to connect to the local-area network that itself is connected to the Internet via what is known in the art as a “direct connection”. In further embodiments, the computer 240 may be connected to the Internet using a cable modem or satellite Internet connectivity.

The system and method herein are not limited to a particular type of network system to which the computers 240 are connected. Typical network interfaces include general-purpose systems such as POTS (plain-old telephone systems) and ISDN (Integrated Services Digital Network), as well as special-purpose systems such as a LAN ((local-area network) or a WAN (wide-area network). Such networking environments are commonplace in offices, enterprise-wide computer networks, intranets and the Internet. In the case of audio data transmitted between handsets, the communication network 238 may involve, for example, conventional switched telephone network hardware or Internet Protocol (IP) networks capable of carrying audio data. If the handsets are mobile devices, they may communicate wirelessly with wireless base stations (not shown). Communication between handsets base stations may involve protocols employed on conventional mobile telephone networks, such as those based on the GSM 900/1800/1900 standards defined by the Groupe Spéciale Mobile (GSM) Association, or protocols employed on wireless data networks, such as those based on the 802.11b (WiFi) or 802.16-2004 (WiMAX) standards defined by the Institute of Electrical and Electronics Engineers (IEEE). Where audio data is transmitted using Voice over IP (VoIP), audio data may be transported using open protocols such as the Internet Engineering Task Force (IETF) Real-time Transport Protocol (RTP). Those skilled in the art will appreciate that the principles of the system and method described herein can be applied to virtually any network system without departing from the scope of the claims and specification herein.

Processor 230 communicates with email system 210, which includes email creation module 212, parsing module 214, transmission module 216, personalized message recognition module 218, and personalized message security module 220. Email creation module 212 is configured to enable the user to compose an email message for transmission to at least one remote server 236. The composed message typically includes text (body of the email message), a subject line, and the identification of recipients (header of the email message), identified by individual email addresses or by email aliases or distribution lists. In those messages in which the message originator desires to customize a single message for different recipients, the text and optionally the recipients' email addresses may include designators identifying the message portions to be transmitted to specific recipients. These designators be of any form known in the art, for example, the inclusion of additional fields in the text and header sections of the message, identifying symbols, colors, highlighting, or other text formatting options, or embedded processing codes. The message portions to be transmitted to specific recipients are linked to or associated with email addresses entered in the header segment of the message.

Parsing module 214 recognizes designators for a specific recipient in email system 210. Upon recognition of the designators, parsing module 214 separates or parses a composed email message to create individualized copies of the original message for each recipient. In an alternate embodiment, parsing module 214 may be located remotely from processor 230, for example, within remote server 236. Transmission module 216 is configured to transmit the individualized copies of the original message to the designated recipients. The designated recipients may have individual email addresses or may belong to different email aliases or distribution lists. The modules of email system 210 may also include additional programmable instructions capable of being executed by processor 230 for performing other functions known in the art for conventional email editors or email systems, such as storing contact information, storing sent and received email messages, searching email messages for particular keywords, adding attachments to composed email messages, etc.

Personalized message recognition module 218 recognizes the presence of an embedded personalized message which has been designated or tagged by the originator of the message. Such recognition is enabled by the ability to recognize and distinguish email addresses from the body of a received email message based on the format of the email address string. Module 218 is engaged when a received email message is replied to, forwarded, and/or moved or copied.

Personalized message security module 220 is responsible for handling email messages that contain embedded personalized messages. Personalized embedded messages may be deleted from the message body, integrated into the message body as a non-personalized sub-message, or retained as a personalized embedded message. Module 220 is called from the personalized message recognition module and passes the message to the email creation module (for forwarding and reply-to options) and/or a storage module.

The particular methods performed by the system for retaining the secrecy of the embedded personalized portion of an email message comprise steps which are described below with reference to a series of flow charts. The flow charts illustrate an embodiment in which the methods constitute computer programs made up of computer-executable instructions. Describing the methods by reference to a flowchart enables one skilled in the art to develop software programs including such instructions to carry out the methods on computing systems. The language used to write such programs can be procedural, such as Fortran, or object based, such as C++. One skilled in the art will realize that variations or combinations of these steps can be made without departing from the scope of the disclosure herein.

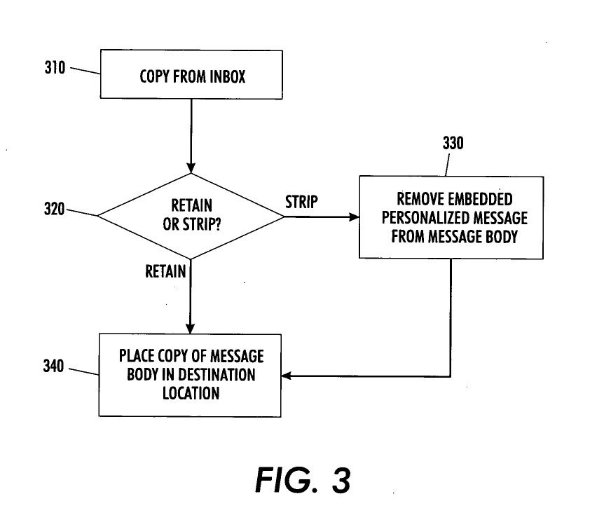

Turning now to FIG. 3, there is illustrated one embodiment of the method for providing security to embedded personalized messages in which security is maintained for messages copied to an extended storage location. When moving an email message containing an embedded personalized message to an extended storage location, the email system, upon detection of the personalized message, provides the user with various options, including stripping the embedded personalized message from the original email, retaining it in its entirety, or retaining a portion of the embedded message and deleting the remainder of the message. The embedded personalized message is identified by the personalized message recognition module and can be displayed to the user via a dialog box. By stripping the embedded personalized message from the email, the user can be assured that all traces of the embedded personalized message are removed, thereby minimizing the risk of a non-intended recipient viewing the embedded personalized message.

This is illustrated in FIG. 3, in which a copy operation is performed to copy the email message from the ‘inbox’ of the recipient at 310. At 320 the email system queries the user as to whether to retain the personalized portion of the message or to strip it from the message. If the user decides to strip the personalized portion, the email system removes the embedded personalized portion of the message from the message body at 330 before placing a copy of the message body in a specified destination location at 340. If the user elects to retain the personalized portion of the message, the entire message is placed in the destination location at 340.

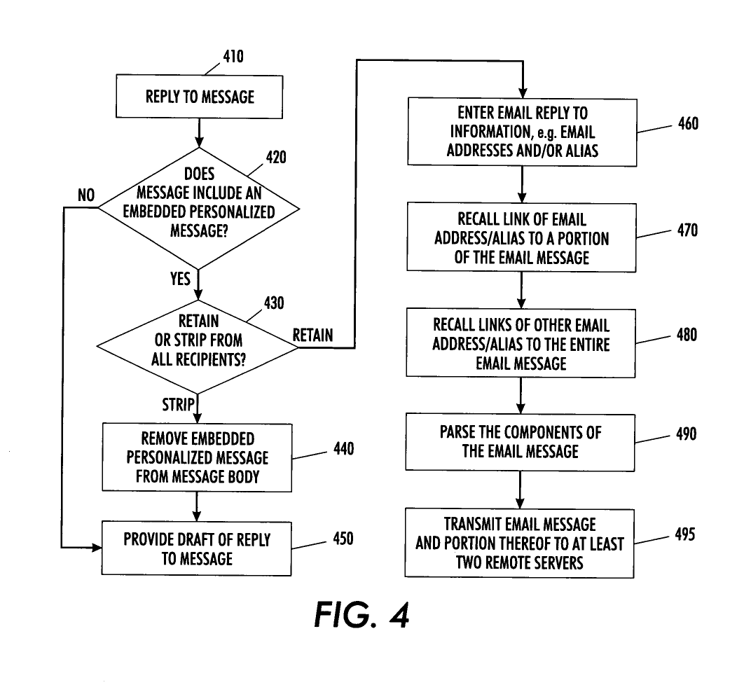

Turning to FIG. 4, there is illustrated one embodiment of the method for providing security to embedded personalized messages in which security is maintained for replies to messages containing a previously authored embedded personalized message. As is known in the art, a reply to an electronic message includes a copy of the original message, which could result in disclosure of the personalized portion of the message to an unintended recipient. For this case, in which the recipient of an embedded personalized message replies to the message sender and/or others, the email system, upon detection of the embedded personalized message, provides the user with the option of stripping the embedded personalized message from the email message or retaining the embedded personalized message only for specific recipients and stripping the embedded personalized portion of the message for the remaining recipients.

At 410 the user instructs the email system that a reply is to be transmitted to a received email message. The email system determines whether the message includes an embedded personalized portion at 420. If an embedded personalized message is not present, the user proceeds to draft a message reply at 450. If an embedded personalized message is present, at 430 a decision is made whether to strip the personalized portion from the original message included with the response or to retain it. If the user decides to strip the personalized portion, it is removed from the body of the original message at 440 and the user proceeds to draft a response to the original message.

If the user decides to retain the embedded personalized portion of the original message, at 460 the user enters the email addresses or distribution list(s) for the recipients of the reply message. The email addresses and links for those recipients who will receive a reply not including the personalized portion of the originator's message are recalled at 470. Links for email addresses of recipients to receive the entire original message are recalled at 480.

For example, an originator may transmit an electronic message to at least two recipients, as illustrated with reference to FIG. 6. While for the purposes of illustration a sample email format for Microsoft® Outlook is utilized, it is noted that the method and system described herein may operate successfully with any known electronic mail application and such use is fully contemplated by the specification and scope of the claims herein. In the example, the original recipients 670 are Tom, Dick, and Harry, and the message body includes an embedded personalized message 630 for Harry. If Harry desires to respond to the message, he may choose to reply to the sender 610 only, reply to the sender 610 and all recipients of the original message, and/or he may forward the message to a new recipient. If ‘reply’ is selected from the user interface of the email application and the user (Harry) chooses to retain the embedded personalized portion of the message, the original link (i.e., the personalized message channel between sender 110 and Harry) is maintained. If Harry elects to reply to the sender 110 and all recipients of the original message, the email addresses, aliases, and/or distribution lists are inspected to determine if they should be included as recipients for the personalized embedded message.

Those addressees who were not the sender 610 or prior recipients of the personalized embedded message are identified as addressees not authorized to receive the embedded message 630 with the reply message 660. However, Harry may choose to add another recipient who would be able to view the personalized embedded message. In this case, the new recipient's email address would be entered on either the “To” or “Cc” sections of the email user interface. For the purposes of this example, the new recipient is Laurie, whose address is entered on “Cc” section 650. Sender 610 and the new recipient, Laurie, would receive the message in its entirety (sections 630, 640, and 660), whereas Tom and Dick would not receive the portion 630 of the original message, thus retaining the security of the embedded personalized message.

The components of the email message are then parsed at 490 to create separate replies for recipients receiving the entire originator's message and those receiving only the portion of the originator's message not containing embedded personalized material. The reply messages are then transmitted to remote servers to be relayed to the recipients at 495.

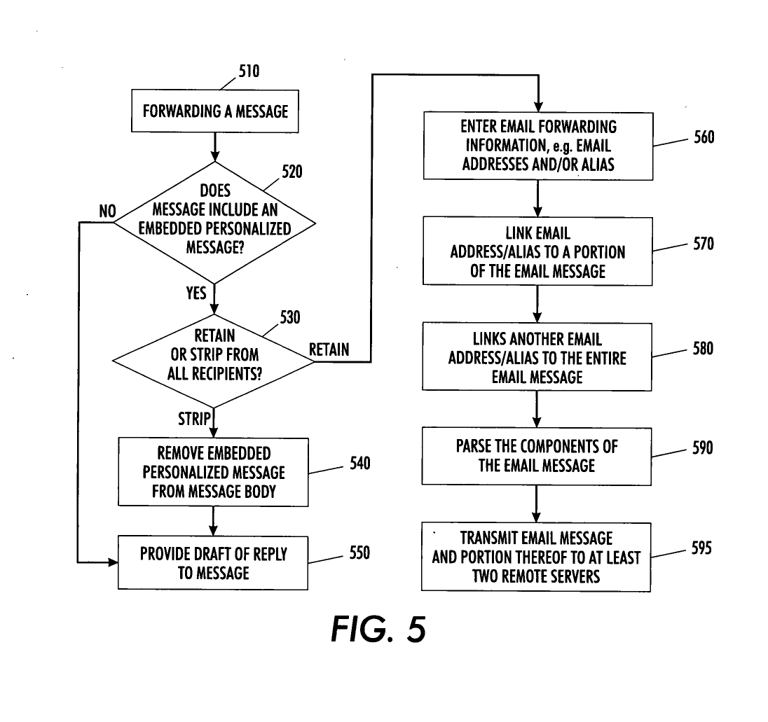

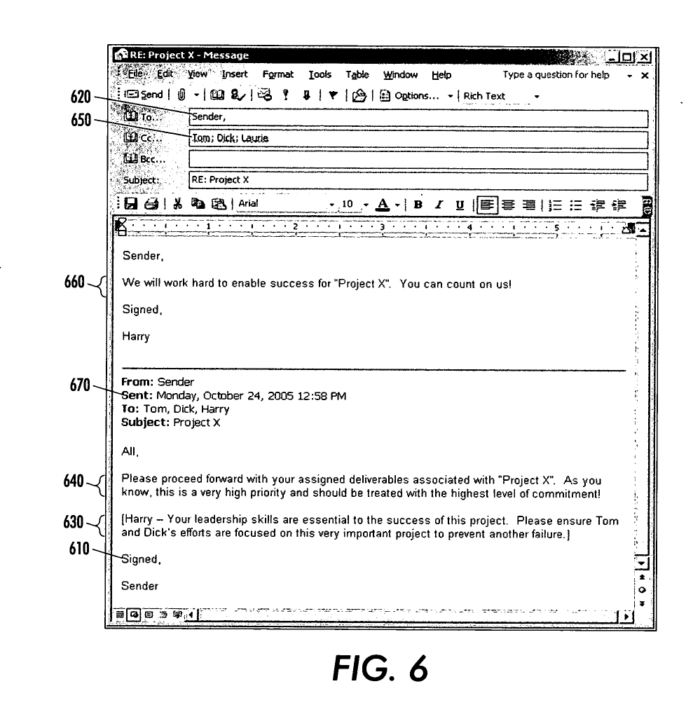

Referring to FIG. 5, there is illustrated one embodiment of the method for providing security to embedded personalized messages which are forwarded to new recipients. As is known in the art, when an electronic message is forwarded, the content of the email message is maintained and the user has the option of appending additional information if needed. In cases in which the forwarding email message contains an embedded personalized message, the sender may or may not choose to retain the embedded personalized message depending on the identity of the intended recipients. Therefore, when forwarding an email message, the email system, upon detection of an embedded personalized message, provides the user with a number of options, including stripping the embedded personalized message from the original email message, retaining the embedded personalized message only for those recipients and the sender originally specified by the sender of the embedded personalized message, or reclassifying the embedded personalized message to include additional recipients not indicated by the original author.

At 510 the user instructs the email system that a received email message is to be forwarded. The email system determines whether the original message includes an embedded personalized portion at 520. If an embedded personalized message is not present, the user proceeds to draft any additional comments to the message before forwarding it at 550. If an embedded personalized message is present, at 530 a decision is made whether to strip the personalized portion from the original message included with the response or to retain it. If the user decides to strip the personalized portion, it is removed from the body of the original message at 540 and the user proceeds to draft any additional comments before forwarding the message at 550.

If the user decides to retain the embedded personalized portion of the original message in the forwarded message, at 560 the user enters the email forwarding information, for example, email addresses or distribution list(s) for the recipients of the original message. Such recipients' email forwarding addresses are identified and linked to the portion of the message not containing the embedded personalized portion at 570. Additional email forwarding addresses are identified and linked to the entire message, including the embedded personalized portion at 580. The components of the email message are then parsed at 590 to create separate messages for recipients receiving the entire originator's message and any additional comments, if any, and those receiving only the portion of the originator's message not containing embedded personalized material with any additional comments. The messages are then transmitted to remote servers to be relayed to the recipients at 595.

While the present discussion has been illustrated and described with reference to specific embodiments, further modification and improvements will occur to those skilled in the art. For example, in the case of a voice mail message, key tones may be utilized to designate the start and end designators of an embedded personalized message. When the message is distributed over the audio transmission network, the server splits the message into two channels to enable some recipients to receive the entire message, while other recipients would receive only a portion of the message. Again, the key tones could be used to flag the start and end positions of the embedded personalized message. Upon receiving a message which contains an embedded personalized message, the receiver would be notified of the embedded personalized message by either the dey tone or replacing it with a pre-recorded statement (for example, “This is the beginning of a confidential message”). Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for maintaining the security of transmitted embedded personalized messages sent over a communication network, the method stored and executed as an application for use by network devices, the method comprising:
receiving a message over the communication network, wherein said message is directed to a first plurality of recipients and wherein each said recipient is identified by a recipient destination descriptor;
selecting an operation to perform on said message, wherein said operation includes at least one member selected from the group consisting of forwarding said message, replying to said message, copying said message to a destination location, or deleting said message;
determining whether said message includes a personalized portion, wherein said personalized portion is directed to at least one of said first plurality of recipients and wherein said personalized portion includes identifying designators which are associated with at least one said recipient destination descriptor;
determining whether to retain said personalized portion of said message prior to performing at least one said operation on said message;
removing said personalized portion of said message if it is determined not to retain it prior to performing at least one said operation on said message; and
performing at least one said operation on said message.

2. The method for maintaining the security of transmitted embedded personalized messages according to claim 1, wherein copying said message to a remote location comprises removing said personalized portion of said message prior to placing a copy of said message body in at least one destination location.

3. The method for maintaining the security of transmitted embedded personalized messages according to claim 1, wherein replying to said message for which the personalized portion is to be retained comprises:
identifying at least one recipient for the reply message;
recalling the destination descriptor for at least one recipient authorized to receive said personalized portion of said message;
recalling the destination descriptors for recipients not authorized to receive said personalized portion of said message;
associating said destination descriptor for said at least one authorized recipient with said identifying designators of said personalized portion;
drafting a text portion for said reply message;
parsing said reply message to create an individual message for each said recipient of said reply message, wherein said individual message including said personalized portion is directed only to said authorized recipients; and
transmitting each said individual message to each said recipient of said reply message.

4. The method for maintaining the security of transmitted embedded personalized messages according to claim 1, wherein forwarding said message for which said personalized portion is to be retained comprises:
identifying at least one recipient for the forwarded message, wherein identifying includes providing destination descriptors;
recalling the destination descriptor for at least one recipient for said forwarded message authorized to receive said personalized portion of said message;
recalling the destination descriptors for the recipients for said forwarded message not authorized to receive said personalized portion of said message;
associating said destination descriptor for said at least one authorized recipient with said identifying designators of said personalized portion;
parsing said forwarded message to create an individual message for each said recipient of said forwarded message, wherein said individual message including said personalized portion is directed only to said authorized recipients; and
transmitting each said individual message to each said recipient of said forwarded message.

5. The method for maintaining the security of transmitted embedded personalized messages according to claim 1, wherein said identifying designators include at least one member selected from the group consisting of identifying symbols, data blocks, formatting, bracketed information, embedded processing codes, bitmaps, the inclusion of additional fields, or key tones.

6. The method for maintaining the security of transmitted embedded personalized messages according to claim 1, wherein said recipient destination descriptor includes at least one member selected from the group consisting of an electronic mail address, an alias, a distribution list, or a telephone number.

7. The method for maintaining the security of transmitted embedded personalized messages according to claim 1, further comprising utilizing a user interface to create, modify, and destroy associations between said recipient destination descriptors and said at least one identifying designator for each recipient of said message.

8. The method for maintaining the security of transmitted embedded personalized messages according to claim 1, further comprises at least one member selected from the group consisting of storing contact information, storing sent and received messages, searching messages for particular keywords, and adding attachments to composed messages.

9. The method for maintaining the security of transmitted embedded personalized messages according to claim 1, further comprising utilizing a remote user interface to compose said message.

10. The method for maintaining the security of transmitted embedded personalized messages according to claim 1, wherein said message comprises a text mail message.

11. The method for maintaining the security of transmitted embedded personalized messages sending text mail messages according to claim 10, wherein associating said recipient destination descriptors with said at least one identifying designator for each recipient of said text mail message is controlled by instructions included in said text mail message or in a text mail protocol.

12. The method for maintaining the security of transmitted embedded personalized messages according to claim 1, wherein said message comprises an audio message.

13. A system for maintaining the security of transmitted embedded personalized messages sent over a communication network, the system storing and executing an application for use by network devices, comprising:
means for receiving a message over the communication network, wherein said message is directed to a first plurality of recipients and wherein each said recipient is identified by a recipient destination descriptor;
means for selecting an operation to perform on said message, wherein said operation includes at least one member selected from the group consisting of forwarding said message, replying to said message, copying said message to a destination location, or deleting said message;
means for determining whether said message includes a personalized portion, wherein said personalized portion is directed to at least one of said first plurality of recipients and wherein said personalized portion includes identifying designators which are associated with at least one said recipient destination descriptor;
means for determining whether to retain said personalized portion of said message prior to performing at least one said operation on said message;
means for removing said personalized portion of said message if it is determined not to retain it prior to performing at least one said operation on said message; and
means for performing at least one said operation on said message.

14. The system for maintaining the security of transmitted embedded personalized messages according to claim 1, wherein copying said message to a remote location comprises removing said personalized portion of said message prior to placing a copy of said message body in at least one destination location.

15. The system for maintaining the security of transmitted embedded personalized messages according to claim 1, wherein replying to said message for which the personalized portion is to be retained comprises:
means for identifying at least one recipient for the reply message, wherein identifying includes providing destination descriptors;
means for recalling the destination descriptor for at least one recipient authorized to receive said personalized portion of said message;
means for recalling the destination descriptors for the recipients not authorized to receive said personalized portion of said message;
means for associating said destination descriptor for said at least one authorized recipient with said identifying designators of said personalized portion;
means for drafting a text portion for said reply message;
means for parsing said reply message to create an individual message for each said recipient of said reply message, wherein said individual message including said personalized portion is directed only to said authorized recipients; and
means for transmitting each said individual message to each said recipient of said reply message.

16. The system for maintaining the security of transmitted embedded personalized messages according to claim 1, wherein forwarding said message for which said personalized portion is to be retained comprises:
means for identifying at least one recipient for the forwarded message, wherein identifying includes providing destination descriptors;
means for recalling the destination descriptor for at least one recipient for said forwarded message authorized to receive said personalized portion of said message;
means for recalling the destination descriptors for the recipients for said forwarded message not authorized to receive said personalized portion of said message;
means for associating said destination descriptor for said at least one authorized recipient with said identifying designators of said personalized portion;
means for parsing said forwarded message to create an individual message for each said recipient of said forwarded message, wherein said individual message including said personalized portion is directed only to said authorized recipients; and
means for transmitting each said individual message to each said recipient of said forwarded message.

17. The system for maintaining the security of transmitted embedded personalized messages according to claim 1, wherein said identifying designators include at least one member selected from the group consisting of identifying symbols, data blocks, formatting, bracketed information, embedded processing codes, bitmaps, the inclusion of additional fields, or key tones.

18. The system for maintaining the security of transmitted embedded personalized messages according to claim 1, wherein said recipient destination descriptor includes at least one member selected from the group consisting of an electronic mail address, an alias, a distribution list, or a telephone number.

19. The system for maintaining the security of transmitted embedded personalized messages according to claim 1, further comprising utilizing a user interface to create, modify, and destroy associations between said recipient destination descriptors and said at least one identifying designator for each recipient of said message.

20. The system for maintaining the security of transmitted embedded personalized messages according to claim 1, further comprises at least one member selected from the group consisting of storing contact information, storing sent and received messages, searching messages for particular keywords, and adding attachments to composed messages.

21. The system for maintaining the security of transmitted embedded personalized messages according to claim 1, further comprising utilizing a remote user interface to compose said message.

22. The system for maintaining the security of transmitted embedded personalized messages according to claim 1, wherein said message comprises a text mail message.

23. The system for maintaining the security of transmitted embedded personalized messages sending text mail messages according to claim 10, wherein associating said recipient destination descriptors with said at least one identifying designator for each recipient of said text mail message is controlled by instructions included in said text mail message or in a text mail protocol.

24. The system for maintaining the security of transmitted embedded personalized messages according to claim 1, wherein said message comprises an audio message.

25. A computer-readable storage medium having computer readable program code embodied in said medium which, when said program code is executed by a computer causes said computer to perform method steps for maintaining the security of transmitted embedded personalized messages sent over a communication network, said method comprising:
receiving a message over the communication network, wherein said message is directed to a first plurality of recipients and wherein each said recipient is identified by a recipient destination descriptor;
selecting an operation to perform on said message, wherein said operation includes at least one member selected from the group consisting of forwarding said message, replying to said message, copying said message to a destination location, or deleting said message;
determining whether said message includes a personalized portion, wherein said personalized portion is directed to at least one of said first plurality of recipients and wherein said personalized portion includes identifying designators which are associated with at least one said recipient destination descriptor;
determining whether to retain said personalized portion of said message prior to performing at least one said operation on said message;
removing said personalized portion of said message if it is determined not to retain it prior to performing at least one said operation on said message; and
performing at least one said operation on said message.
